(19) United States
(12) Patent Application Publication
(10) Pub. No.: US 2019/0179665 A1
(43) Pub. Date: Jun. 13, 2019

(54) APPARATUS AND METHOD FOR COORDINATING A CONFIGURATION OF A MICROCONTROLLER SYSTEM

(71) Applicant: ProJoule GmbH, Freising (DE)

(72) Inventor: Horst Diewald, Auenstr (DE)

(21) Appl. No.: 16/310,178

(22) PCT Filed: Jun. 17, 2016
(86) PCT No.: PCT/EP2016/064044

§ 371 Date: Dec. 14, 2018

(51) Int. Cl. G06F 9/48; G06F 9/22; G06F 9/4401

(52) U.S. Cl. CPC G06F 9/4812; G06F 9/4411; G06F 9/22

(57) ABSTRACT

Apparatus and methods for coordinating a configuration of a microcontroller system is provided. An exemplary method includes determining a set of configuration data of a plurality of sets of configuration data. The plurality of sets of configuration data are associated with at least one operational unit, wherein the at least one operational unit is associated with the microcontroller system. Each set of the plurality of sets of configuration data defines a configuration of the at least one operational unit, and each set comprises coordination information to coordinate a transition to the configuration of the at least one operational unit. The method further includes configuring the microcontroller system corresponding to the determined set of configuration data. Configuring the microcontroller system includes coordinating the transition to the configuration according to the coordination information. The coordinating employs one or a plurality of coordination states, wherein each coordination state is associated with at least partly configuring the at least one operational unit according to the configuration, and/or configuring the at least one operational unit by an intermediate configuration.

### FIELD

Aspects of the present disclosure relate to configuring the hardware of a microcontroller system based on configuration data. More specifically, the present application relates to coordinating a transition to a configuration of operational units associated with a microcontroller system.

### BACKGROUND

A computer system usually includes a programmable unit, such as a CPU, and memory, on which program code to be executed by the programmable unit, and data related to an application running on the computer system can be stored. Memory may be classified as read-only memory (ROM), non-volatile memory (i.e. Flash) and random access memory (RAM). A computer system furthermore includes peripheral units for providing input/output, clocking, power, and/or co-processors or hardware accelerators for providing specific computing tasks.

A microprocessor usually does not have large amount of memory, such as RAM and ROM, and other peripheral units on the chip. Even though according to recent developments, high performance microprocessors may also have cache memories, graphical processing units and other accelerators on-chip, they usually have a high amount of resources like RAM, ROM, I/O ports, etc., to be added externally in order to provide a functional microprocessor computer system. Microprocessors may have applications that are usually not dedicated to specific hardware.

A microcontroller system, for example, has a programmable unit, in addition with a fixed amount of code and data memory, and other operational or peripheral units all integrated on a single chip. Microcontroller systems are therefore often referred to as system-on-chip (SoC) and/or as system-in-package (SiP) computer systems. Microcontroller systems may be designed for specific applications, i.e. to permit conducting of end-user related coordinated functions, tasks, or activities. As an example, a microcontroller system application processes an input provided by some peripheral units, and provides an output based on the processing. Microcontroller systems typically need small resources in terms of RAM, ROM, Flash, I/O ports, etc., which may be embedded, as mentioned, on a single chip or system-in-package. This in turn reduces the size and the cost compared to microprocessor systems.

Microcontroller systems are capable of using different configurations of their hardware. For example, the operational units associated with a microcontroller system can be individually configured to tailor energy consumption and/or to provide different levels of safe operation. Developers provide an increasing number of options e.g. for ultra-low energy consumption, such as power gating and clock gating implementations for configuring individual portions, pieces of hardware or hardware circuits (e.g., operational units, functional islands), or software instances used to program the CPU and/or other hardware associated with a microcontroller system thereby increasing complexity. With respect to operational safety, individual operational units may be configured with different levels of access rights and ownership. For example, a section in a memory may be protected such that it can be read during normal operation of the system, but not be overwritten. In another example, an operational unit may be configured such that certain access rights are required by other pieces of the hardware or by the software to access the circuit. Often, the configuration of the individual hardware circuits associated with a microcontroller system involves more than 200 parameters that have to be defined. It is therefore a challenge for the users of the microcontroller system to provide applications that make use of the microcontroller system in an energy-optimized fashion with an appropriate level of operational safety, in order to optimize energy consumption and/or safety per performed task, to achieve fast development time, and reduce software maintenance efforts. The designer of such microcontroller systems faces the challenge to design a scalable hardware beneficially for software programmers. Software has to properly handle the transition conditions between configurations. Further, the configuration data shall enable software to be used in different hardware compositions using portions of the configuration data identifying the structure and arrangement of the set of configuration data.

Thus, there is considerable need for apparatuses and methods that offer flexible, scalable and simplified handling of microcontroller system configurations. In particular, need arises for coordinating the transition to a configuration of a microcontroller system when a large number of operational units is involved.

### SUMMARY

The present invention provides apparatus and methods for coordinating a configuration of a microcontroller system using a set of configuration data of a plurality of sets of configuration data to identify relevant data and coordinate a transition to a configuration associated with at least one operational unit of the microcontroller system.

In some aspects, a microcontroller system is provided. The microcontroller system comprises a central processing unit, memory associated with the microcontroller system, and configuration control means. The configuration control means is operable to determine a set of configuration data of a plurality of sets of configuration data associated with at least one operational unit, wherein the at least one operational unit is associated with the microcontroller system. Each set of said plurality of sets of configuration data defines a configuration of said at least one operational unit. Furthermore, each set comprises coordination information to coordinate a transition to said configuration of said at least one operational unit. The configuration control means is further operable to configure the microcontroller system corresponding to said determined set of configuration data. The configuring of the microcontroller system includes coordinating the transition to said configuration according to said coordination information, wherein said coordinating employs one or a plurality of coordination states, each coordination state being associated with at least partly configuring said at least one operational unit according to said configuration, and/or configuring said at least one operational unit by an intermediate configuration.

In other aspects, a method of configuring a microcontroller system is provided. The method includes determining a set of configuration data of a plurality of sets of configuration data. The plurality of sets of configuration data are associated with at least one operational unit, wherein the at least one operational unit is associated with the microcontroller system. Each set of the plurality of sets of configuration data defines a configuration of the at least one operational unit, and each set comprises coordination information to coordinate a transition to the configuration of the at least one operational unit. The method further includes configuring the microcontroller system corresponding to the determined set of configuration data. The configuring the microcontroller system includes coordinating the transition to the configuration according to the coordination information. The coordinating employs one or a plurality of coordination states, wherein each coordination state is associated with at least partly configuring the at least one operational unit according to the configuration, and/or configuring the at least one operational unit by an intermediate configuration.

In further aspects, a computer program is provided that comprises program instructions which are computer-executable to implement the steps of determining a set of configuration data of a plurality of sets of configuration data. The plurality of sets of configuration data are associated with at least one operational unit, wherein the at least one operational unit is associated with a microcontroller system. Each set of the plurality of sets of configuration data defines a configuration of the at least one operational unit, and each set comprises coordination information to coordinate a transition to the configuration of the at least one operational unit. The program instructions are further executable to implement configuring the microcontroller system corresponding to the determined set of configuration data. The configuring the microcontroller system includes coordinating the transition to the configuration according to the coordination information. The coordinating employs one or a plurality of coordination states, wherein each coordination state is associated with at least partly configuring the at least one operational unit according to the configuration, and/or configuring the at least one operational unit by an intermediate configuration.

Various objects, features, aspects, and advantages of the present disclosure will become more apparent from the following detailed description, along with the accompanying drawings in which like numerals represent like components.

### DESCRIPTION OF THE DRAWINGS

In order to better understand the present disclosure and to appreciate the practical applications thereof, the following figures are provided and referenced hereafter. It should be noted that the figures are given as illustrative examples only and in no way limit the scope of the disclosure.

FIG. 1 is a simplified diagram of a microcontroller system.

FIG. 2 illustrates a simplified diagram of a microcontroller system according to aspects of the present disclosure.

FIG. 3 illustrates an exemplary example of a coordination process related to configuring operational units of a microcontroller system in form of a Petri Net according to aspects of the present disclosure.

FIG. 4 illustrates a state diagram of an example coordination process related to configuring operational units of the microcontroller system according to aspects of the present disclosure.

FIG. 5 illustrates an exemplary example of a coordination process related to configuring operational units of a microcontroller system in form of a Petri Net according to aspects of the present disclosure.

FIG. 6 illustrates a state diagram of an example coordination process related to configuring operational units of the microcontroller system according to aspects of the present disclosure.

FIG. 7 illustrates an exemplary example of a coordination process related to configuring operational units of a microcontroller system in form of a Petri Net according to aspects of the present disclosure.

FIG. 8 illustrates a state diagram of an example coordination process related to configuring operational units of the microcontroller system according to aspects of the present disclosure.

FIG. 9 shows a block diagram illustrating the stages performed by the microcontroller system in processing an event according to aspects of the present disclosure.

FIG. 10 illustrates processing of an event according to an example technique according to aspects of the present disclosure.

FIG. 11 illustrates processing of an event according to another example technique according to aspects of the present disclosure.

FIG. 12 illustrates a simplified diagram of a configuration control means of a microcontroller system according to aspects of the present disclosure.

FIG. 13 is a block diagram illustrating a method according to aspects of the present disclosure.

### DETAILED DESCRIPTION

The present invention will be described hereinafter in more detail with reference to the accompanying figures, in which examples of exemplary embodiments of the invention are illustrated. However, the present invention may be embodied in different forms and should not be construed as limited to the illustrative examples set forth herein. Rather, these examples are provided so that this disclosure will be thorough and will convey the scope of the invention to persons skilled in the art.

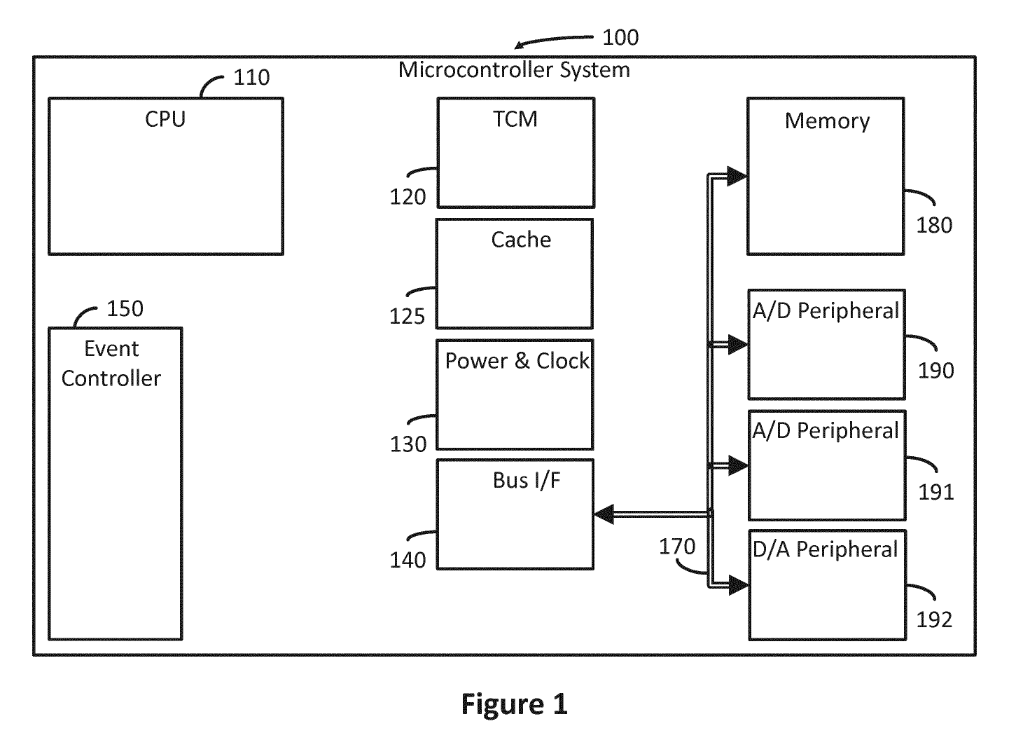

FIG. 1 is a simplified diagram of a microcontroller system 100. The microcontroller system 100 may include a central processing unit (CPU) 110 and an event controller 150 for receiving and handling events, such as interrupts or wake-up signals arriving from other entities implemented in hardware and/or software, including entities internal and/or external to the microcontroller system. The event controller 150 may be coupled to a tightly coupled memory (TCM) 120 and to a cache memory 125, a power and clock unit 130, and a bus interface (I/F) 140. Any kind of data, such as program data and data related to applications running on the microprocessor system may be transmitted via bus 170 between memory 180 and bus interface 140. Bus 170 may also couple to analog/digital peripheral units 190, 191 and digital/analog peripheral unit 192. Peripheral units 190 and 191 may relate to analog to digital converters (ADC), whereas peripheral unit 192 may refer to a digital to analog converter (DAC). Hence, peripheral units 190, 191 and 192 serve to provide input and output for the microcontroller system, respectively. Peripheral units 190, 191 and 192 may also relate, respectively, to input/output entities, such as keyboards, displays, or mass storage, etc. Memory 180 and peripheral units 190, 191 and 192 may also be coupled to event controller 150, e.g., via the bus interface (I/F) 140 and bus 170 for providing configuration signals to configure the respective hardware circuits. In the same manner, the coupling of event controller 150 with the CPU 110, the TCM 120 the power and clock system 130 and the bus interface 140 serves to configure the respective units. Event control means 150 may support vectored events, nesting of interrupts of different priorities, etc.

In operation, an event (e.g., an interrupt, an exception, a TRAP, a wake-up signal, etc.) may arrive at the event controller to trigger the microcontroller system to perform a task. The event controller may trigger configuration of the hardware circuits associated with the microcontroller system to properly handle the request behind the interrupt.

However, while conventional methods allow for configuring microcontroller systems according to some specific or desired configuration, it cannot be specified how to transit from a previous configuration to a new configuration. A need may therefore arise to optimize the “choreography” of applying a configuration to operational units in terms of power consumption and/or execution speed. This may be especially the case when many operational units of the microcontroller system are involved in a configuration.

There are cases where the configuration of a second operational unit depends on the first operational unit being already configured. As an example, a second operational unit may have to wait until a first operational unit provides a stable power supply or a stable clock signal to it. Conventionally, operational units that depend on the configuration of another unit may wait for a local signal, such as a “ready” signal before applying the configuration. Often, digital circuits may settle quickly after being powered up, and are immediately ready for operation. In contrast, power gating, for example, may require capacitors to support peak energy during switching and operational activity. The power gate transistor and capacitor may constitute a highly variable delay element. Powering-up power-gated circuits usually needs the respective supply voltage being settled before the hard- and/or software can reliable interact with other circuits. Moreover, upon power-up or upon change of their operation parameters, analog circuits may require settlement of their voltage until reliable operation can be ensured. Examples that require to settle for proper operations are, e.g., when a comparator is switched from low speed to high speed, a voltage reference is to be powered up, a channel to an A/D converter is to be selected, etc.

Furthermore, in some cases, an operational unit may be internally designed to conduct initialization steps in a specific order. For example, the ramp-up behavior of subsystems of a microcontroller system may be determined by the hardware designer of that component. However, such local and “hard-wired” solutions are inflexible and do not allow to optimize system performance and/or energy consumption of the entire system. Hence, even when there are no strict sequential dependencies, application designers and programmers of microcontroller systems may wish to optimize the dynamic process when a microcontroller system transits to a new configuration.

A need for a more flexible handling of microcontroller system configurations may therefore exist. Embodiments of the present invention therefore involve coordination information to coordinate a transition to a configuration of operational units of the microcontroller system.

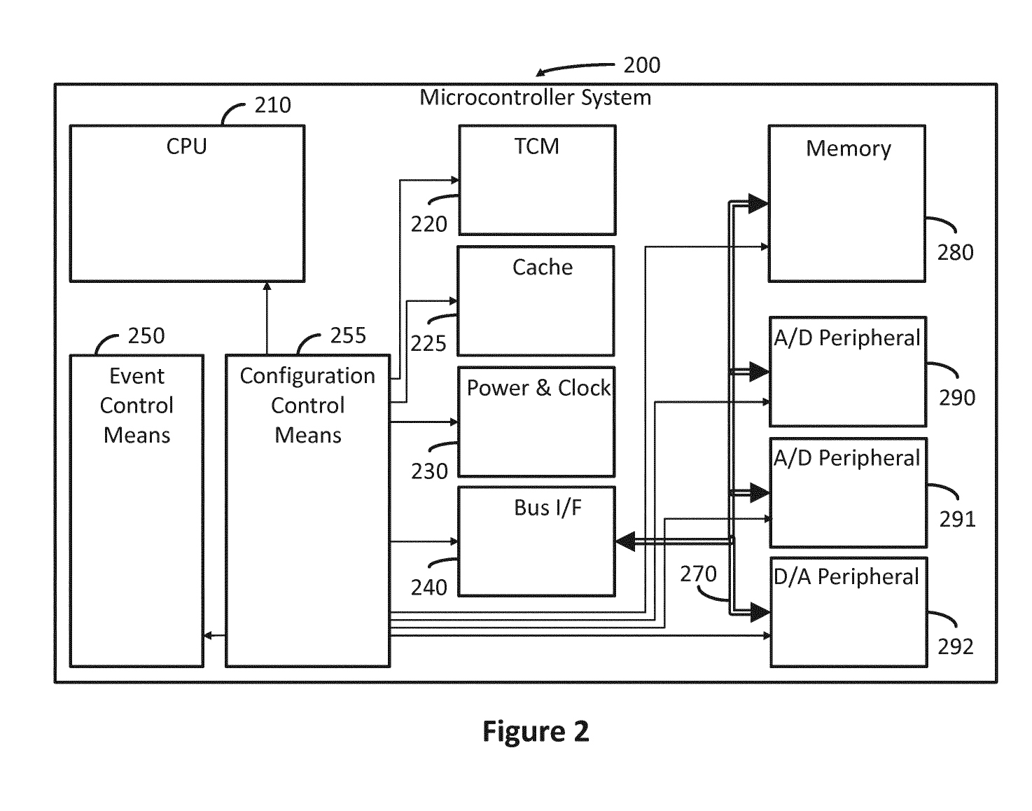

FIG. 2 illustrates a simplified diagram of a microcontroller system 200 according to aspects of the present invention. The microcontroller system 200 may comprise different operational units, such as functional islands or operational modules (e.g., electronic circuits, hardware of the microcontroller system configurable with respect to power gating and/or clock gating and/or safety aspects, such as limiting access based on access rights). Among those operational units associated with the microcontroller system are a central processing unit (CPU) 210, tightly coupled memory (TCM) 220, cache memory 225 associated with the microcontroller system, and configuration control means 255. TCM 220, which can be used by CPU 210 for storing program and data information, is a low-latency memory having predictable access times. Cache memory 225 may be partitioned into program cache and data cache. In some cases, more than one CPU is used in the microcontroller system. Operational units may also relate to software, e.g., a software thread or a process used to program the CPU and/or other hardware. For example, specific functions may be provided by software routines and/or by instances of software objects. More specifically, for example, hardware units may be driven by software to provide a front end for the user, where specifics of accessing the hardware are hidden to the user. In another example, specific functionality may be provided by software instances as an abstraction layer over basic instructions of the CPU or other hardware units. In other examples, software instances may instantiate a software process, e.g, by allocating memory associated with the process to store data relevant to the process instance, and by executing program software associated with the process. In view of the present disclosure, an operational unit may relate to any instance associated with a microcontroller system using electronic hardware circuitry and/or software, including microcode or firmware, or any combination thereof to provide a functionality of the microcontroller system. As mentioned, a microcontroller system is often implemented as a system on chip or a system in package. Operational units may be internal or external to the chip or package, wherein their configuration is controllable by the microcontroller system, e.g., by configuration control means 255, as described below.

The event control means 250 according to FIG. 2 is operable to receive an event, e.g., an interrupt, an exception, a TRAP, a wake-up signal and/or other signals triggering an action of the microcontroller system. The event control means 250 may support vectored events, nesting of events of different priorities, etc. Event control means 250 may support hardware and software events. Hardware events may be triggered by circuits outside the microcontroller, or by operational units that are part of the microcontroller system itself. Software events may be triggered from software being executed on the microcontroller system, e.g., by using a specified command. The event control means 250 may be operable to monitor hardware and software interfaces for incoming events and accept, mask (e.g., drop) or queue a particular event based on priority associated with the event. As mentioned, the microcontroller system 200 may further comprise a power and clock unit 230 for supplying the system, or at least parts thereof, with respective power and clock signals, and a bus interface (I/F) 240 for providing appropriate signals for bus 270. Some systems may include more than one power and clock unit, each of which supplying different parts of the microcontroller system with respective power and clock signals, and/or more than one bus interfaces, e.g., when the system includes more than one bus. Moreover, the microcontroller system according to this example includes A/D peripherals 290 and 291, which may be implemented as analog-to-digital converters (A/D converters), and D/A peripheral 292, which may be implemented as a digital-to-analog converter (D/A converter), as known by persons of ordinary skill in the art.

According to some aspects, configuration control means 255 may be adapted to configure the operational units of the microcontroller system, which is illustrated in FIG. 2 by the lines originating from the configuration control means 255. In some examples, a dedicated bus system for providing configuration signals between configuration control means 255 and other operational units is provided. Additionally, or alternatively, bus 270 may be used for transmitting configuration signals. Configuration control means 255 may also be coupled to bus 270 (not shown in FIG. 2). Events may be provided to the configuration control means 255 when they are accepted by event control means 250. It should be noted that the operational units of microcontroller system 200 as shown in FIG. 2 are for illustration only. Other microcontroller systems according to the invention may include different architectures of operational units that may interact differently.

In some aspects, the configuration of the operational units may be related to energy consumption and/or safe operation of the microcontroller system. As an example, energy consumption of a microcontroller system can be influenced by power gating, clock gating, and/or dynamic voltage/frequency scaling of operational units associated with the system. In power gating, the supply voltage of an operational unit can be switched either on or off. In this way, static energy consumption of operational units (e.g., due to leakage currents semiconductor devices) can be minimized. Clock gating may reduce the dynamic or switching energy consumption of operational units. Clock gating turns off clocks, thereby freezing the operational state while still maintaining the original functionality of a unit. A further technique to tailor energy consumption of an operational unit is dynamic voltage/frequency scaling. Usually, the maximum frequency at which a hardware component can operate is dependent on the supply voltage. For example, operational units may operate based on a supply voltage that is reduced compared to the maximum supply voltage. In these cases, the maximum frequency at which the system can operate is reduced. However, in these configurations, the energy consumption is limited compared to operation at maximum supply voltage and clock frequency. On the other hand, at high supply voltages and clock frequencies, computational speed is increased, but the static and dynamic energy consumption is also increased. Therefore, in cases where an operational unit may not require the full computational performance, supply voltage as well as clock frequency may be reduced at the same time, achieving a lower energy consumption.

Safe operation of the microcontroller system may be required for preventing resources of the system (e.g., operational units, such as memory segments or other operational modules) from intentionally or unintentionally being corrupted. For example, faults may occur when two or more different units of program execution (e.g., threads) are running in multi-tasking operation. In this case, a first thread may intentionally or unintentionally corrupt the code, data, or stack of another thread. In order to separate the resources of different threads and protect them from intended or unintended access, segments of memory and/or operational units of the microcontroller system may be configured with different levels of protection and access rights. Furthermore, upon detection of a fault, operational units may be configured with a specific protected state in order to recover from fault. For example, such a safe environment may be implemented in a way operational units are associated with identification numbers and/or vectors (ID). A currently active ID, ID_{now} and a future IDₙₑₓₜ associated with an operational unit (after a new configuration getting active) may be part of the configuration data. The currently active ID_{now} associated with the operational unit may be compared with the ID_{now} according to the configuration data, where, in case it matches, the process continues. Otherwise the mismatch may be signaled to a safe operation hard- or/and software instance. Furthermore, the currently active ID_{now} may be part of the return data available in a return situation (IDᵣₑₜᵤᵣₙ=ID_{now}), e.g, from an event, where a safe operation hard- or/and software instance may check whether IDᵣₑₜᵤᵣₙ equals ID_{now} and issue an alert when both IDs are not equal. In other examples, the IDₙₑₓₜ may be used to replace the current active ID_{now} in a “rolling key” mechanism. For example, the replacement may be used to protect the parts of the same system ensuring safe/secure operation in a dynamical way. Furthermore, the ID mechanism in this example may be used to verify that in specific situations the used hard- and/or software (e.g., an event service routine, ESR) match. The ID protection may also be used for specific hard- and/or software partitioning in a microcontroller system and for safe or secure encapsulation from other partitions.

In some aspects of the present disclosure, configuration control means 255 is operable to determine (e.g., identify) a set of configuration data of a plurality of sets of configuration data. The plurality of sets of configuration data are associated with at least one operational unit. The at least one operational unit is associated with the microcontroller system. In the techniques described herein, each set of said plurality of sets of configuration data define a configuration of said at least one operational unit. Furthermore, each set may comprise coordination information. The latter coordination information is to coordinate a transition to a configuration of said at least one operational unit. Furthermore, the configuration control means is operable to configure the microcontroller system corresponding to the determined set of configuration data. The configuring the microcontroller system includes coordinating the transition to the configuration according to the coordination information. The coordinating further employs one or a plurality of coordination states, wherein each coordination state is associated with at least partly configuring said at least one operational unit according to said configuration, or configuring said at least one operational unit by an intermediate configuration, or both.

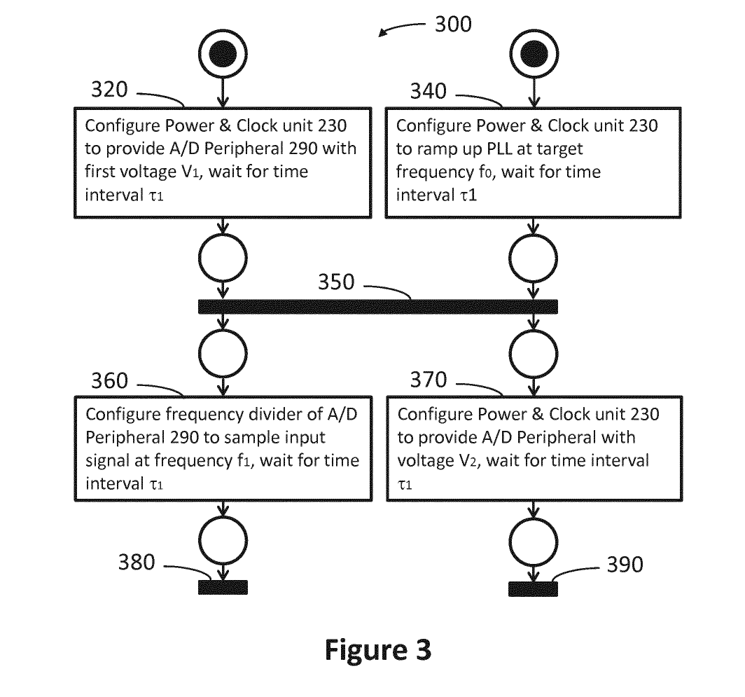

FIG. 3 illustrates an exemplary example of a coordination process related to configuring operational units of the microcontroller system according to aspects of the present disclosure. It should be noted that this example is for illustration purposes only, and therefore in no way limiting the scope of the present invention. In FIG. 3, a Petri Net 300 (also known as a place/transition net or P/T net) is used for illustrating this process. In particular, a Petri Net allows to model parts of the configuration being conducted concurrently. In this example, the target configuration may involve configuring power and dock unit 230 in FIG. 2 to provide electric power at a specific voltage and a clock signal at a specific dock frequency to A/D peripheral 290. Exemplarily, the A/D peripheral settles faster to be operational if a first voltage V₁ higher than operational voltage V₂ is applied for a first time interval τ₁.

As illustrated in transition 320, power and clock unit 230 is first configured to provide A/D peripheral 290 with a first voltage V₁. As illustrated by Petri Net 300, concurrently by transition 340, power and clock unit 230 is configured to ramp up its PLL to target frequency f₀. After expiry of a first time interval τ₁, it may be guaranteed that the output voltage of the power and clock unit 230 is sufficiently settled, and that the target frequency f₀ is stable. This is in FIG. 3 modeled as no-operation (NOP) transition 350. Configuration control means 255 may then configure a frequency divider within A/D peripheral 290 to sample an incoming signal at a first frequency f₁ (see transition 360 in FIG. 3), wherein frequency f₁ may be of an integer ratio of target frequency f₀. Concurrently to process 360, in transition 370, configuration control means 255 may configure power and dock unit 230 to provide A/D peripheral 290 with a second voltage V₂, which may be the operating voltage of A/D peripheral 290. In this example, the first voltage V₁ is significantly higher than the second voltage V₂ to accelerate power ramp-up of A/D peripheral 290. The coordination process of the configuration may be finished at NOP transitions 380 and 390, respectively.

As can be seen from this illustrative example, the respective coordination information associated with the plurality of sets of configuration data generally defines a “choreography” to coordinate the transition or the transitions to a configuration (e.g., the first configuration, such as target frequency f₀ and voltage V₂ for power and clock unit 230, and sampling frequency f₁ for A/D peripheral 290) of one or more operational units. In some aspects, by determining a set of configuration data of a plurality of sets of configuration data, wherein the plurality of sets are each associated with (the same) at least one operational unit (wherein for illustrative purposes in the present example the at least one operational unit may include power and clock unit 230 and A/D peripheral 290), it is possible to provide different coordination information associated with a configuration (e.g., the first configuration of power and clock unit 230 and A/D peripheral 290, as mentioned above) of the operational unit(s). A configuration in this respect may cover a part of or all aspects configurable with the one or more operational units. For example, an operational unit may be configurable by multiple parameters, where the configuration as discussed above is associated with a part of those parameters, while other parameters of the operational unit may be configured with a fix or a default parameter setting. More specifically, in the above-described example, power and clock unit 230 may not only supply A/D peripheral 290 with a supply voltage and a clock frequency, but also other units, which may be configurable separately by parameters related to supply voltages and/or dock frequencies from power and clock unit 230. Furthermore, the first set of configuration data defining the first configuration and coordination to that configuration of the at least one operational unit may be partly overlap with a second set of configuration data defining a different configuration (or coordination information) of the at least one operational unit. In this case, the first and second sets of configuration data may coincide partly. For example, a set of configuration and coordination data may include parameter values stored in a piece of memory accessible by the microcontroller system. In this case, the overlapping part associated with two or more sets of configuration data may need to be stored only once to save memory space.

In an example, a default coordination information may be stored in a ROM mask of the microcontroller system or may implicitly be defined by the hardware designer of those operational unit(s), as discussed above. By determining a set of configuration data of the plurality of sets of configuration data, the application designer or programmer of the microcontroller system may be able to use one or more different alternative sets of configuration data related to the configuration of the operational unit(s) to tailor power consumption and/or operational speed. In this respect, he is not barred to a default coordination process for a configuration. To illustrate this with respect to the example of FIG. 3, a default configuration may not foresee providing first voltage V₁ and then the second voltage V₂ as explained above. Therefore, by determining a set of configuration data including coordination information as described, ramp-up of A/D peripheral 290 can be accelerated to optimize the time until the system is ready to operate. In other examples, more than one alternative set of configuration data in addition to a default coordination process may be provided to tailor the coordination to various conditions. In some aspects, the plurality of sets of configuration data associated with at least one operational unit may include only one set. The determining may be omitted in this case.

In some aspects, the configuration control means may be operable to determine or identify the set of configuration data of the plurality of sets of configuration data during a startup, boot, or reset state (or mode). In some examples, the determined or identified set of configuration data may then be valid for the entire duration of system operation (e.g., until the next startup, boot, or reset is being performed). In this case, the determined set of configuration data may be used for appropriately configuring the microcontroller system and coordinating the transition to that configuration each time the corresponding configuration of the system is triggered. Hence, in this example, by de-coupling the determination of a set of configuration data and the configuration of the microcontroller system, the determination of a valid set of configuration data does not need to be repeated every time a configuration corresponding to the determined configuration data is triggered.

In some aspects, the determining of a set of configuration data may not or not only be accomplished at startup of the system. Rather, the determining of a set of configuration data may be conducted at an instant when the system is to be configured to the aforementioned configuration e.g., in reaction to an incoming event, etc. In these aspects, for example, configuration control means 255 may be fully operable as described herein when the microcontroller system is in a normal state of operation (such as a run state/mode, idle mode, etc.), in which a central processing unit of the microcontroller system (such as CPU 210) is configured and/or available for handling instructions of an application program. Such normal state of operation may be different from a startup, boot, or reset state (or mode), in which only system programs, for example, microcontroller system setup is operated in order to initialize or reset the system into a defined initial configuration. Parts of the plurality of sets of configuration data may reside in a memory (such as a ROM, or other non-volatile, or other types of memory), wherein additionally or alternatively parts of the sets of configuration data may be loaded to a memory (e.g., into a configuration register) during system start.

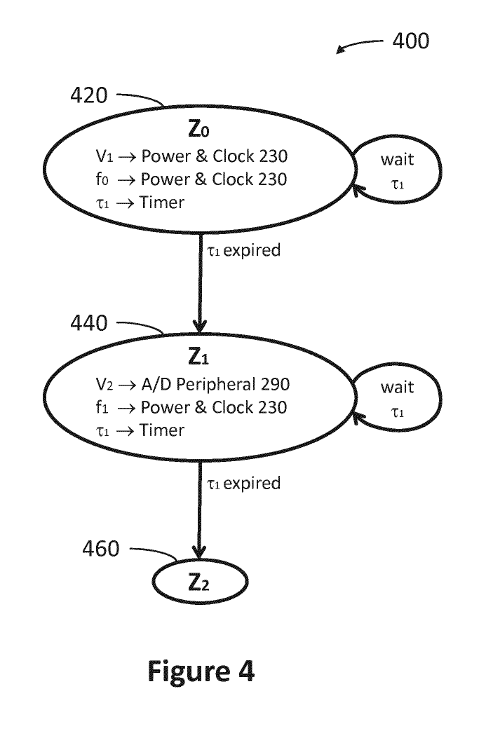

As mentioned, the configuration control means is operable to coordinate the transition to a configuration (e.g., the first configuration, as mentioned above) based on the coordination information. In some aspects, in order to facilitate the coordination, the coordinating employs one or a plurality of coordination states, which will be illustrated in more detail in the following. Again, only as a non-limiting example, FIG. 4 illustrates a state diagram 400 of an example coordination process related to configuring operational units of the microcontroller system according to aspects of the present disclosure. This state diagram refers to the coordination process 300 as already illustrated in FIG. 3. In order to coordinate power and clock unit 230 and A/D peripheral 290, two coordination states, Z₀ 420 and Z1 440 are provided in FIG. 4. The coordination process starts in state Z₀ 420. In this state 420, power and clock unit 230 is configured with the first voltage V₁. Furthermore, in state Z₀, power and clock unit 230 is concurrently configured with target frequency f₀. As can be seen, the state diagram in FIG. 4 resolves the concurrency of processes 320 and 340 by configuring two parameters at the same time in state Z₀. Furthermore, in order to accomplish the configuration, a time determining element, such as a timer, which may be part of configuration control means 255, or power and clock unit 230 or any other accessible operational unit for this purpose, may be started to trigger a state transition from state Z₀ to state Z₁ after expiry of the first time interval τ₁. When state Z₁ is reached, A/D peripheral 290 is concurrently configured with first frequency f₁, and power and dock unit 230 is configured with the second voltage V₂. Coordination state Z₁ may be left after another first time interval τ₁ has expired into state Z₂, where it is guaranteed that frequency f₁ and second voltage V₂ is sufficiently stable. State Z₂ may be a return state from the coordination process. As can be seen from this example, by employing one or a plurality of configuration states, the configuration of a microcontroller system can be accomplished in a coordinated manner. While a target configuration (e.g., the first configuration, such as target frequency f₀ and voltage V₂ for power and clock unit 230, and sampling frequency f₁ for A/D peripheral 290) may refer to a setting of operational unit(s) suitable to operate the system, e.g., to run an application or a part thereof, such as an interrupt service routine, coordination states may relate to intermediate states of the operational unit(s) which are not necessarily intended or suitable for operating the system. In the example according to FIG. 4, states Z₀ and Z₁ are coordination states. In state Z₀, power and clock unit 230 is configured with frequency f₀. The clock frequency of power and clock unit 230 is therefore already being set to its target value. However, in state Z₀, A/D peripheral 290 is not fully configured to its target configuration. Hence, state Z₀ is associated with partly configuring power and clock unit 230 and A/D peripheral 290 toward the target configuration. In some examples, partly configuring may therefore exclude fully configuring the at least one operational unit according to the target configuration. On the other hand, in state Z₀, power and clock unit 230 is configured with intermediate voltage V₁, which is different from target voltage V₂. Therefore, state Z₀ is as well associated with configuring power and clock unit 230 and A/D peripheral 290 by an intermediate configuration. In state Z₀, neither an operation in a previous configuration of the microcontroller system, nor an operation in the target configuration might be possible, because in this coordination state the output voltage and the output frequency of power and dock unit 230 are not settled and ready for operation.

Correspondingly, in coordination state Z1, power and clock unit 230 is configured with voltage V₂. Furthermore, A/D peripheral 290 is configured with target frequency f₁. Hence, in state Z₁, the target configuration is finalized by partly configuring power and dock unit 230 and A/D peripheral 290. In coordination state Z₁, the output voltage of the power and clock unit and the output frequency of A/D peripheral 290 may not be settled and ready for operation. However, in return state Z₂, the target configuration is considered settled. In some aspects, a coordination state may be associated with partly configuring the at least one operational unit according to a target configuration. Additionally, or alternatively, a coordination state may be associated with configuring the at least one operational unit by an intermediate configuration, wherein the latter may differ from a target configuration. In some aspects, there may be only one coordination state. In some aspects, the coordinating may employ a plurality of coordination states. The handling of coordination states and the corresponding configuration steps may be implemented by electronic hardware circuits in configuration control means 255, or any other suitable circuitry associated with microcontroller system 200.

In some aspects according to the present disclosure, each set of said plurality of sets of configuration data includes one or more parameter values being stored in a data structure. The parameter values define the configuration (e.g., the target configuration associated with the determined set of configuration data) of the at least one operational unit and the coordination information (and/or their location). In these aspects, the configuration control means may be further operable to identify a data structure of the determined set of configuration data and extract the parameter values.

This step may involve identifying the determined set of configuration data, ascertaining internal structure of the configuration data, e.g. the length, order and content, and the coordination information towards the target configuration to coordinate the transition to the latter configuration including intermediate configuration steps. In some examples, the coordination data may include conditions for the transition to specific and target configurations, as will be explained below.

In the exemplary example according to FIGS. 3 and 4, the determined set of configuration data may include a data vector element D₁=(V₁, f₀, τ₁, V₂, f₁, τ₁), where each of these parameter values may be represented as binary digits of an appropriate length. In this example, parameters relate to the target configuration, such as target frequency f₀ and target voltage V₂ of power and clock unit 230 as well as to coordination information. A data structure for a set of configuration data may include additional information, such as an identifier of the operational unit to which the elements of the data vector should be applied to, an identifier identifying the particular coordination stages and association information on which parameters shall be applied in which configuration state, and other information coded to define the configuration data and coordination information. In some aspects, different data structures may be defined. A data structure identifier may be used to distinguish the different data structures. In an exemplary example, the configuration control means is operable to identify a data structure of the data elements of the determined set of configuration data and extract the respective parameter values related to the one or the plurality of coordination states.

In some aspects according to the present disclosure, the plurality of sets of configuration data comprise at least two sets of configuration data defining a same configuration of said at least one operational unit, wherein each said at least two sets of configuration comprise different coordination information. In these aspects, alternative possibilities of coordination for transition to the same (target) configuration associated with the at least one operational unit may be provided. In one example, a first set of configuration related to a specific configuration may include coordination information designed to provide a fast transition to the target configuration. A second set of configuration data related to that specific configuration may include coordination information designed to provide transition designed to save power.

In some aspects according to the present disclosure, the coordination information may comprise an indication of a sequence of the one or more coordination states. For example, with reference to FIG. 4, the coordination information may include an indication of the sequence of coordination states Z₀ and Z₁. In some general aspects, the indication of a sequence of the one or more coordination states may include an indication of the particular parameters to be used in each one of the coordination states according to this sequence. For example, in FIG. 4, in state Z₀ the parameters V₁ and f₀ are used to accomplish configuration, whereas in state Z₁ parameters f₁ and V₂ are used for configuring power and clock unit 230 and A/D peripheral 290, respectively. By defining a sequence of one or more coordination states, the coordination of the configuration can be sub-divided into different stages, wherein in each stage the configuration is accomplished in part. This allows, e.g., resolving dependencies. In the example of FIGS. 3 and 4, the configuration of the power and clock unit 230 may have to be performed first before A/D peripheral 290 can be configured. However, there may also be examples where it is useful to divide a configuration into several stages, even though there is no strict dependency of an operational unit on a particular configuration of another unit. As shown above with respect to FIGS. 3 and 4, power and clock unit 230 is first configured with increased voltage V₁ and then with a lower voltage V₂ to accelerate power ramp-up. However, in other examples, it may be necessary to smoothen the voltage ramp in order to avoid voltage drops. In these cases, voltage V₁ may be chosen lower than V₂. In a different example, a low-power oscillator may be provided in a first coordination state with a first voltage which is higher than a second voltage necessary for normal operation of the oscillator, so that the system more quickly settles to normal operation.

In some aspects according to the present disclosure, the coordination information may include an indication of a latency for a transition from one of said coordination states to a next state. The latency may be a time interval measured in seconds, or correspondingly a number of clock or instruction cycles, etc. As shown in the exemplary example of FIG. 4, a first time interval τ₁ is employed to trigger a state transition from coordination state Z₀ to coordination state Z₁. In the present case, it may be guaranteed that the target frequency f₀ is stable after time interval τ₁. Hence, defining an indication of a latency time may be useful in all cases where stable operation of an operational unit can be guaranteed after expiry of a latency time. It should be noted that at least in some cases, it may be useful to define a latency different from a default latency which may be stored in a ROM mask, as discussed above. For example, with respect to FIGS. 3 and 4, a default latency τ₀ larger than τ₁ may be foreseen by the microcontroller manufacturer by default in order to provide a time interval that safely works for all cases (e.g, all target frequencies of power and dock unit 230). However, for the specific ramp-up scenario with target frequency f₀ for the power and dock unit 230 it may be sufficient to assume time interval τ₁. In another example, a default latency interval τ₀ may be provided by the microcontroller manufacturer in a ROM mask that is safe for all manufacturing tolerances. However, a lower latency τ₁ may be sufficient based on measurements of settling time of an operational unit e.g. during or after the manufacturing process of the microcontroller system. In this case, the lower latency τ₁ may be used to override the courtesy value foreseen by the manufacturer. Hence, providing an indication of a latency for transition of one coordination state to a next state may help to optimize power consumption and/or performance of the microcontroller system. In some examples, the next state is a next one of the coordination states. In other examples, the next state is not a coordination state, such as state Z₂ in the example of FIG. 4.

In some aspects of the present disclosure, the coordination information may include trigger information for a transition from one of said coordination states to a next state, said trigger information may identify a trigger condition. One of the trigger conditions may be, as mentioned, a latency triggering a transition of coordination states. However, there may also be a combination of conditions possible to trigger a coordination state transition. For example, as mentioned with reference to FIGS. 3 and 4, the time interval for configuring the power and clock unit 230 may be dependent on the target frequency, the frequency difference, etc. Hence, trigger information for a transition from one coordination state to a next state may be dependent on the configuration to which an operational unit is to be configured to (e.g., the first configuration, as mentioned above). In a different example, instead of a settling time τ₁ the configuration according to FIGS. 3 and 4 may be accomplished by providing power and clock unit 230 and A/D peripheral 290 with signals that indicate settlement related to voltage V₁ and frequency f₀ to configuration control means 255.

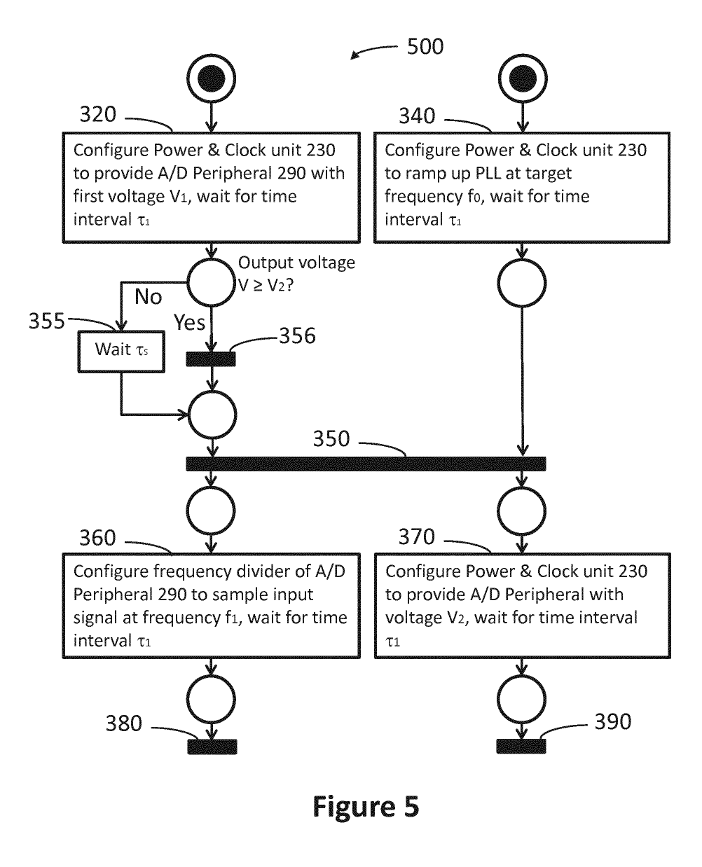

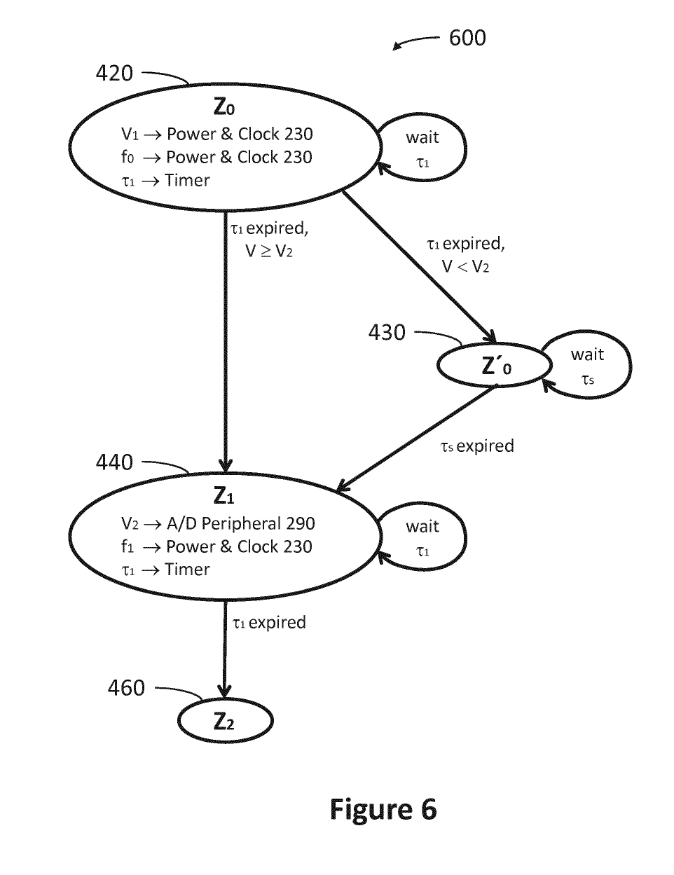

In some aspects of the present disclosure, trigger information may include branching information for a transition from said one of said coordination states to either a first next state or a second next state. This is illustrated in an exemplary and non-limiting example with respect to FIGS. 5 and 6, showing an extension of the scenario as discussed in FIGS. 3 and 4. In FIG. 5, a Petri Net 500 (also known as a place/transition net or P/T net) is used for illustrating this process. In addition to the scenario as shown in FIG. 3, after time interval τ₁ has expired in transition 320, it is tested whether the output voltage V of power and clock unit 230 has reached voltage V₂. In this respect, it should be remembered from the discussion of FIG. 3 above, that power and clock unit 230 is configured in transition 320 to output voltage V₁ which is higher than V₂ to accelerate settling to target voltage V₂. Hence, in the present case, it is tested whether an output voltage higher than V₂ is already achieved after time interval τ₁ has expired. In this case, the intended acceleration of the configuration can be regarded as successful. However, in case output voltage V is less than V₂, for safety reasons, a further time interval τₛ is awaited (transition 355) in order to let the output voltage converge towards target voltage V₂. Further examples for trigger conditions may include an operating voltage too low or high, progress or status information of an application task, guiding data or signals from debug HW/SW, the source of the trigger, etc.

FIG. 6 illustrates the corresponding state diagram 600. As illustrated, based on the trigger information, i.e., whether or not the output voltage V is higher or equal than V₂, the next coordination state is Z₁ or Z′₀, respectively. In state Z′₀, expiration of time interval τₛ is waited for before state Z₁ is reached. It should be appreciated that this example is in no way limiting the scope of the present disclosure. Branching into different states can in general be useful when the coordination of the configuration depends on some further conditions, such as operating conditions of the microcontroller system, or trigger conditions comprising a signal fed back from at least one operational unit of the microcontroller system. In some aspects, a first next state may be a coordination state. In some aspects, a first next state may not be a coordination state. Similarly, in some aspects, a second next state may be a coordination state. In some aspects, a second next state may not be a coordination state.

In some aspects of the present disclosure, the configuration control means is further operable to determine branching information and to adjust the configuration based on the branching information. This may be useful in cases where operating conditions of the microcontroller system during coordination process, such as available battery voltage, temperature, system load, etc., may indicate that the target configuration should be modified. In some aspects, the configuration control means may be operable to adjust the (target) configuration based on a feedback signal from the at least one operational unit. Such feedback allows to flexibly adapt the configuration. In some cases, configuration control means 255 may configure the at least one operational unit (e.g., in a first coordination state) to provide a feedback signal or data. Configuration control means 255 may further be operable to, adapt the configuration of the at least one operational unit (e.g., in a second coordination state), based on the feedback signal.

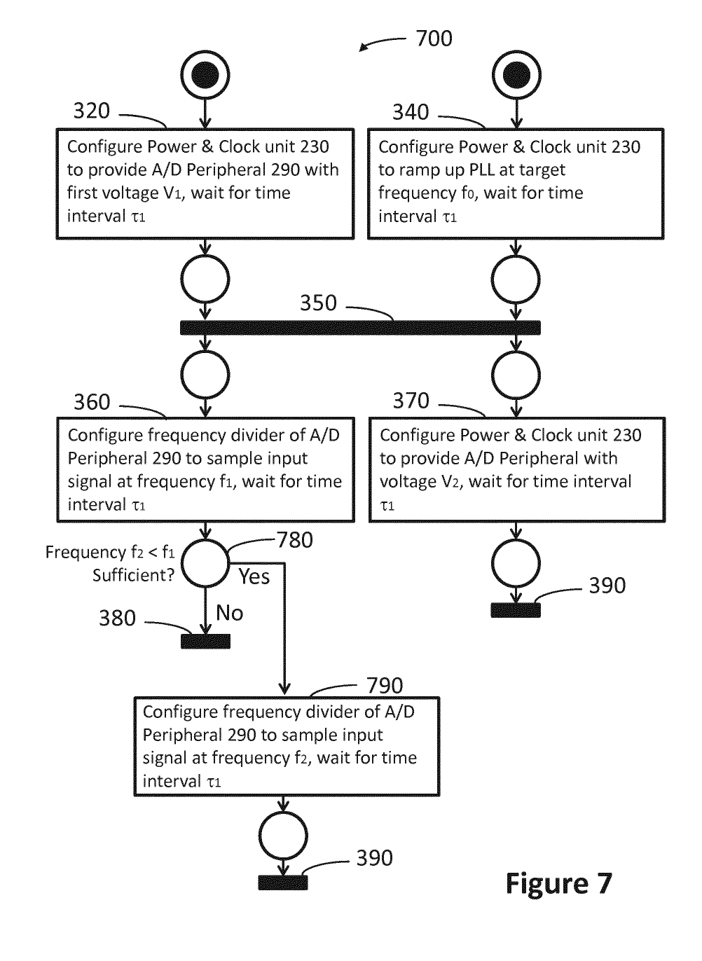

FIG. 7 illustrates an exemplary non-limiting example of a coordination process related to configuring operational units of a microcontroller system in form of a Petri Net according to aspects of the present disclosure. In some aspects, this process is an extension of the scenario as discussed in FIGS. 3 and 4, where after configuring A/D peripheral 290 to sample the incoming signal at first frequency f₁, it is assessed at place 780, based on the incoming signal, whether it is sufficient to sample the incoming signal with a lower frequency f₂<f₁. In an example, the number of zero crossings of the incoming signal at A/D peripheral 290 are counted based on a signal sample measured during performing the process of transition 360, i.e. during time interval τ₁. In another example, the dynamic range of the incoming signal is assessed. In this example, A/D peripheral 290 may be an analog-to-digital converter (ADC) of Sigma-Delta type. As known by persons skilled in the art, the dynamic resolution of these ADCs is proportional to the sampling frequency. In any case, a lower operating frequency f₂ may significantly reduce power consumption for operating A/D peripheral 290. In some aspects, this example may also include a variant as explained with reference to FIGS. 5 and 6.

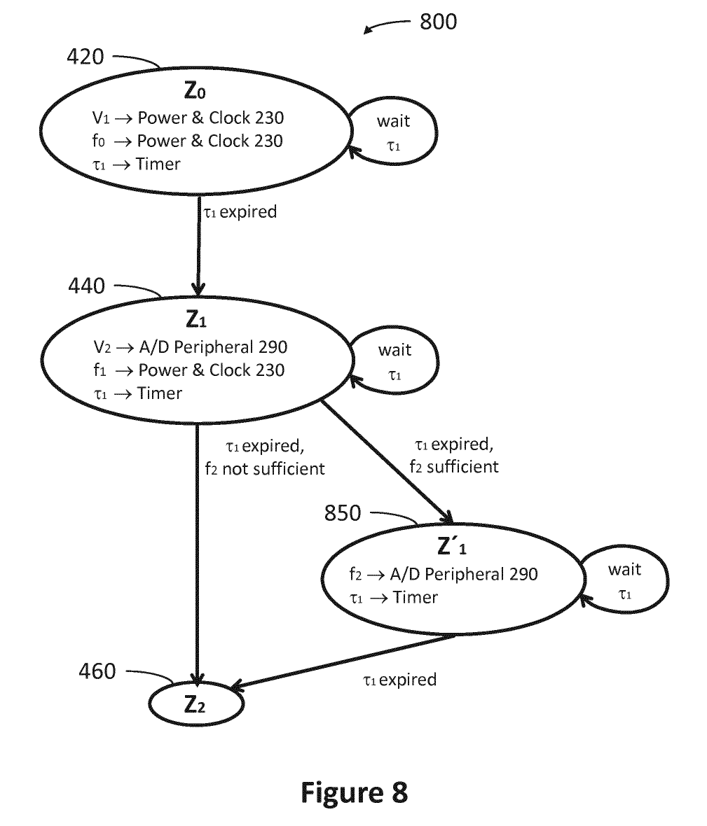

FIG. 8 illustrates a state diagram related to the example coordination process illustrated in FIG. 7. Compared to the coordination processes as discussed with FIGS. 4 and 6, the coordination information includes an additional coordination state Z′₁. Furthermore, trigger information for coordination state Z₁ may indicate to branch to coordination state Z′₁ when a lower operating frequency f₂<f₁ is sufficient for operating A/D peripheral 290, as explained above. It should be noted that in this example, the assessment of whether a lower operating frequency is sufficient is based on the configuration of A/D peripheral 290 with f₁. In particular, without first configuring the microcontroller system according to this configuration, it would not be possible to make this assessment of the branching information.

In coordination state Z′₁, the frequency divider of A/D peripheral 290 is configured with frequency f₂ instead of frequency f₁, which is lower, thereby saving power for sampling the input signals to A/D peripheral 290. After expiry of time interval τ₁, coordination state Z′₁ is left to terminate the configuration at state Z₂. Back to coordination state Z₁ 440, the trigger information may indicate to terminate the configuration at state Z₂ when it is determined that the higher frequency f₁ is required to sample the input signals to A/D peripheral 290. As can be noted from the examples given in FIGS. 7 and 8, by determining branching information based on the configuration and adjusting at least one parameter associated with the configuration, an improved configuration can be facilitated.

In some aspects of the present disclosure, the microcontroller system may comprise an event receiving means operable to receive an event, such as event control means 250 as shown in FIG. 2. Furthermore, the configuration control means, such as the configuration control means 255 in FIG. 2, may be further operable to collect the plurality of sets of configuration data related to the event from the memory. Furthermore, the determining of the set of configuration data may be based on the collected plurality of sets of configuration data.

As the plurality of sets of configuration data are related to a particular event, the coordination to a configuration, (e.g. the first configuration, as mentioned above) may be conducted upon arrival of a specific event. In an example, upon arrival of a specific event, the microcontroller may be configured based on the event, e.g., configured suitable for executing an associated event service routine with optimized power and/or security settings. A configuration based on an event is further specified in application PCT/EP2015/061274, filed on May 21, 2015, also assigned to the applicant of the present disclosure, which is expressly incorporated by reference herein in its entirety. Events may be provided to the configuration control means 255 when they are accepted by event control means 250. As mentioned, in case the configuration data is related to a particular event, also the coordination information can be tailored for transiting to that configuration in an optimum fashion. As an example, an event may require reading input data from A/D peripheral 290, as explained with relation to FIGS. 3-8. In this case, the configuration as referenced in FIGS. 3-8 may be triggered by the event, and the coordination of the transition to that configuration may be accomplished as explained above.

Furthermore, by collecting the plurality of sets of configuration data from the memory, the particular coordination information (e.g., the collecting of the plurality of sets of configuration data, and/or the determining of a set of configuration data of the plurality of sets of configuration data) may be based on the event. This may include collecting pre-configured sets of configuration data that relate to the event or a specific group of events, e.g., in reaction to the event received and accepted by event receiving means 250, or based on an event being expected to be received, e.g., depending on a particular operational state or scenario of the microcontroller system. These examples may include determining a set of configuration data in reaction to the event, e.g., based on arguments of the event vector, and/or based on a configuration that was active upon receiving the event, based on the application (e.g. the unit of program execution) that triggered the event, etc. Therefore, it is possible to provide coordination information that can be individually adapted to operating conditions when an event is received or expected. Furthermore, in some aspects, as the collecting of the plurality of sets of configuration data, and/or the determining of a set of configuration data of the plurality of sets of configuration data may be based on the event, the amount of coordination information that is to be considered in the sets of configuration data may further be reduced. More specifically, in these cases, only that coordination information may be considered in the sets of configuration data that may be respectively different from a pre-defined or default configuration. For example, with reference to FIGS. 3-8, only the coordination information related to power and clock unit 230 and A/D peripheral 290 may be considered in the sets of configuration data.

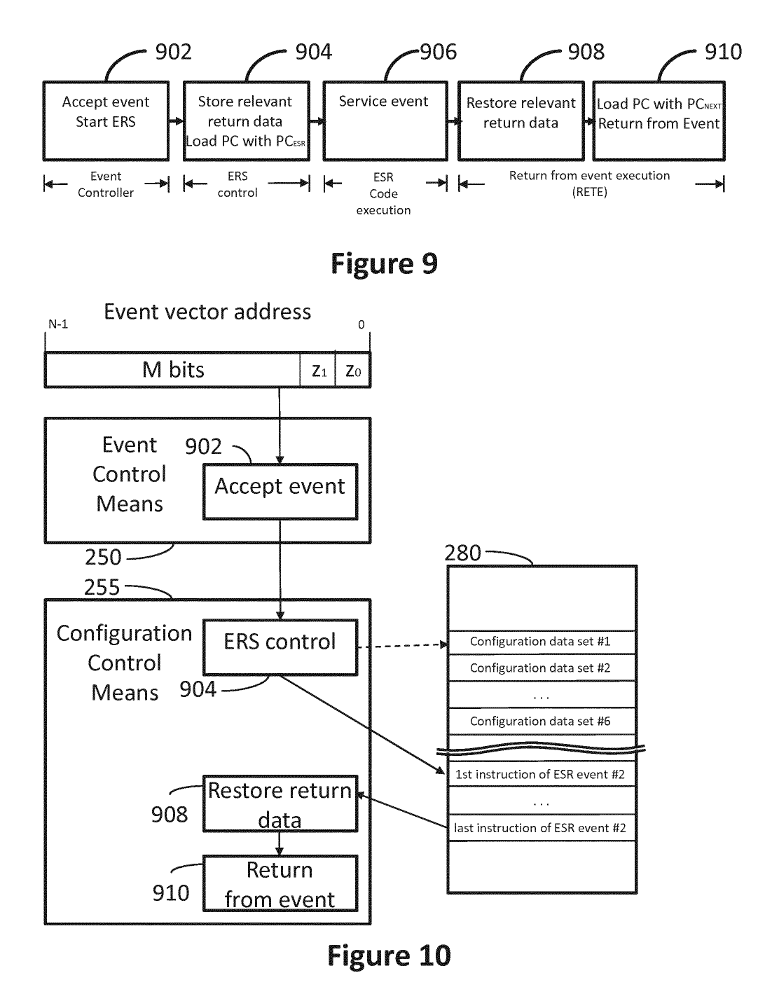

Referring now to FIG. 9, a block diagram is shown illustrating the stages performed by the microcontroller system in processing an event using the techniques according to aspects of the present disclosure.

Upon arrival of an event, processing of the event starts with stage 902. This stage may be executed by event control means 250 of the microcontroller system 200 as shown in FIG. 2. When the event is accepted, the process is further executed by the event request service (ERS) control stage 904. The ERS control stage switches from execution of the process that was present when the event arrived to the execution event service routine (ESR) for handling the event. The steps performed during the ERS control stage may be implemented by a hardware state machine in the event control means 250 and/or in the operation mode control means 255, or in any other operational unit of the microcontroller system. In some examples, the ERS control stage 904 may be provided at least in part as an atomic process. In an atomic process, the steps performed by the state machine are performed in an atomic manner, i.e., the procedure is, when initiated, then executed without being interrupted by any intervention from software (e.g., from the operating system, software events, etc.), or some other hardware. In this way, data that is involved in an atomic process cannot be corrupted, thereby ensuring safe operation. Atomic operation is in particular of advantage when a processing condition is in change, i.e., during switching from execution of a previous process to servicing the event, changing the configuration of an operational unit, e.g., by transitioning from one operation mode into another, or by configuring the microcontroller system according to a determined set of configuration data, etc., as discussed above. Atomic behavior may be selectable at runtime by an atomic bit, which may, e.g., be part of an event vector, or an argument of an event vector. For example, an atomic bit, when set, may indicate to CPU 210 that a number of cycles or instructions (e.g., to conduct ERS control stage 904 or parts thereof) may be operated in an atomic manner, i.e., without being interrupted. In this way, atomic behavior can be defined in a flexible way. In some examples, multiple bits may indicate, e.g., a number of cycles during which CPU 210 shall operate in an atomic manner. The multiple bits may be included in the coordination information.

In order to switch from execution of the process that was present upon arrival of the event, the ERS control stage 904 may stop the latter process and save all information that is necessary for restoring the execution after returning from the event. This data may be denoted as return data. The return data includes, for example, the program counter (PC) of the process executed upon receiving the event pointing toward the instruction that is to be executed next, the status register (SR) or registers of the CPU, including the processor status word (PSW). The return data may also include the present pointer to the stack. In some designs, for reasons of operational safety, all CPU registers may be stored as well, even though they may not be touched during execution of the interrupt service routine. The return data may be stored on a stack memory configured in memory 220 or 280, respectively. In some embodiments, the CPU itself may include memory for the stack. The stack pointer is updated accordingly. Furthermore, in order to execute the event service routine (ESR), the program counter of the CPU may be loaded with the program counter PC_{ESR} of the event service routine pointing toward the first instruction thereof.

In order to implement the concepts according to the present disclosure, the ERS control stage 904 may also include the ability to change from a system configuration active upon receiving the event to a new target system configuration, wherein the transiting to the new system configuration is facilitated according to the methods as explained above. In order to provide the ability to return to the configuration that was active upon receiving the event, the respective system configuration may be saved. After saving the system configuration information of the configuration (or, e.g., the corresponding pointer) that was active upon receiving the event, the ERS control stage may collect one or a plurality of sets of configuration data including coordination information from memory 220, 225 or 280. Moreover, the ERS control stage may determine a set of configuration data of the sets of configuration data. Furthermore, the ERS control stage 904 may configure the microcontroller system 200 corresponding to the determined set of configuration data. Transition to the configuration may be accomplished according to the coordination information, using the concepts as explained above. The ERS control stage may further trigger execution of the event service routine (ESR) 906 in order to service the event.

As mentioned above, the advantage of implementing the operation of the configuration control means 255 at least in part within the boundaries of atomic operation (e.g., the steps related to the ERS control stage), is that execution of this stage cannot be disrupted, and the respective data cannot be corrupted by some faulty conditions that may occur when storage process 904 is interrupted by another process. For example, the latency to start with the ESR 906 may be minimized by having a well-defined number of data to be stored during storage process 904, e.g., a defined number of CPU registers, peripheral registers, etc. The restoring process 908 may also rely on correct return data and correct number of return data so that the return process is correctly executed. However, for example, in case the storage process 904 is interrupted by another process, a faulty condition, as mentioned above, may occur. In this case, the interrupting process may have no indication that the storage process is still in progress. This may end in an unsafe operation in a critical scenario that may even be hard to identify. In order to avoid such faulty conditions, in some examples, the steps related to collecting the set(s) of configuration data, the determining a set of configuration data, and/or the configuration of the microcontroller system according to the determined set of configuration data performed by configuration control means 255 may be performed within the boundaries of atomic operation, initiated by configuration control means 255 and/or the event control means 250 without any intervention of an operating system. Some examples may also include the steps of saving system configuration information associated with a system configuration active upon receiving the event and the execution of the event service routine within the atomic operation boundaries of the ERS control stage 904. Furthermore, in some examples, the entire process triggered by receiving the event until returning from the event may be within the boundaries of atomic operation, to conduct event service in an energy and performance efficient way. In other examples, atomic operation may be divided into multiple parts of atomic operations, which reduces latency, as the portions underlying atomic operations may be fix by implementation or be controlled by configuration control means. Such divided atomic operation may be useful to ensure that all steps are executed in the required sequence and in the required configuration. Stage 906 in FIG. 9 is the execution stage of the event service routine. During this stage, the event is serviced using the configuration of the microcontroller system as described above.

After execution of the event service routine is terminated, the processor state of the process that was active upon receiving the event may be restored in order to continue execution of the latter process. In microcontroller systems, the return data as mentioned above, e.g. the program counter of the process executed upon receiving the event, the status register or registers of the CPU, including the processor status word, etc., may be restored from the stack or the stacks in order to switch from execution of the event service routine to continue the process executed by the microcontroller system 200 that was present upon receiving the event. This is performed during the return from event (RETE) stages 908 and 910. In stage 908, the return data as described above is restored. During stage 910, the program counter is loaded with the next instruction PC_{NEXT} of the program flow of the process to be returned to.

RETE stages 908 and 910 may also include the ability to restore the system configuration active upon receiving the event. In this respect, e.g., RETE stage 908 may also include restoring the configuration information associated with the system configuration active upon receiving the event, and e.g., RETE stage 910 may also include configuring the microcontroller system corresponding to the system configuration active upon receiving the event, as described above. However, in order to coordinate the restoring of the previous configuration, the sets of configuration data may also include coordination information to coordinate the restoring of the previous configuration. The return from event stages 908 and 910 including the restauration of the system configuration as described may be implemented by the configuration control means 255 and/or the event control means 250 using an atomic process that is initiated without any intervention of an operating system and cannot be interrupted within the boundaries of atomic operation, as discussed above. In some situations, however, restauration of the system configuration that was active before receiving the event may not be useful. This may be indicated at runtime (e.g., as an argument of an event vector) by a return data indicator defining the behavior of the RETE stage 908. In an example, a sequence of events may be expected requiring a particular target configuration. In such cases, a configuration may be kept after the return from the respective event so that repeated re-configuring of the microcontroller system can be avoided.

In some aspects of the present disclosure, the set of configuration data may be determined based at least in part on event execution control data associated with the event. In some aspects, any information that is available at the time when the event is received can be used as execution control data. For example, event execution control data may be data that is received with the event or may be otherwise available at the time instant when the event is received. As a more specific example, an event signal may comprise an event vector identifying the event, and include a pointer pointing toward a program counter of an event service routine. The event vector may further include arguments (e.g., parameters) for configuring the event. In some aspects, techniques according to the present disclosure may include determining the set of configuration data including the coordination information based on the address and the arguments of the event vector.

In some aspects according to the present disclosure, the event execution control data may include system state information associated with the execution status of the microcontroller system. Execution status information may be associated with information characterizing an inner state of the system at the time when the event arrives. Examples of such data may be the content of program status registers, condition code registers, the program stack storing return data, peripheral unit status, i.e., data needed to continue the interrupted process after the event is served, status of operational units, etc.

In some aspects according to the present disclosure, the system state information includes a system configuration active upon receiving the event. In some examples, this information may be stored on a stack for serving the event, in order to return to the system configuration that was active upon receiving the event. In some cases, the system configuration that was active upon receiving the event may not provide sufficient resources for serving the event. Hence, for serving the event, for example, some operational units of the microcontroller system shall be properly configured. Therefore, the configuration of the microcontroller may be changed, an appropriate set of configuration data including the coordination information for applying this change may be determined for transiting to the configuration used to service the event.

In some aspects according to the present disclosure, program code associated with an event service routine for handling the event and said sets of configuration data is stored in respective portions of the memory 220, 225, 280, wherein a memory location for collecting said sets of configuration data including the coordination information is based on an event identifier associated with said event. In some examples, the configuration data include a definition of a particular target configuration of the microcontroller system (e.g., a set of respective configuration parameters related to the operational units to be configured), the coordination information to transit to said particular target configuration, as well as the structure information about the set of configuration data. In some examples, the memory location for collecting the sets of configuration data from the memory as explained above may be derivable from an event identifier, e.g., an event vector or an event signal, etc., so that collection of the sets of configuration data including the coordination information can be accelerated. Furthermore, it is to be appreciated that the configuration data need not be stored in a register, which is rather expensive. Rather, for storing the configuration data, the same type of memory which is also used for storing the event entry pointer and/or code of the event service routine can be used. This enables an inexpensive design for different configurations of the system. Furthermore, the set of configuration data in the memory can be changed in case of a software or hardware modification by changing the data in the memory without executing a dedicated step to store new configuration data in a register.

FIG. 10 schematically illustrates processing of an event according to an example technique related to aspects of the present disclosure. According to this example, an event #2 may arrive having an event identifier, such as an event vector of length N bits 0 . . . N−1 as illustrated in FIG. 10. However, any other identifier unambiguously identifying the event #2 may be used. In this example, the most significant M bits may be used as the effective program counter address PC_{ESR} pointing toward the first instruction of the event service routine (ESR). In this example, the event vector address may additionally comprise two selector bits z₀ and z₁, which may be regarded as arguments of the event identifier.

For processing of the event, in this example, event control means 250 may accept the event by executing control stage 902, as explained above. Further, in the present example, configuration control means 255 may execute ERS control stage 904. As explained above, in stage 904 all information that is necessary for restoring the execution after returning from the event may be saved. Furthermore, stage 904 includes the collecting of the sets of configuration data. As an exemplary example, configuration data sets #1 to #6 are collected by configuration control means 255 from memory 280, as illustrated in FIG. 10. In the present example, configuration data sets #1, #2, #3, #4, #5 and #6 are stored in a portion of memory 280 which is separate from the location where the program data related to the event service routines are stored. This may be advantageous in cases where the configuration data sets may apply to different events, selector bits, event parameters or arguments, etc.

In some examples, collecting configuration data sets may include retrieving the data from the memory and store the data in a register associated with configuration control means 255. Alternatively, as shown in FIG. 10, a pointer (illustrated by the dashed arrow in FIG. 10) is obtained that points toward the start address related to configuration data set #1. Such a pointer may be known from an initialization of configuration control means 255. As a further alternative, respective pointers pointing toward configuration data sets #1, #2, #3, #4, #5 and #6 may be obtained based on the event identifier.

Further in ERS control stage 904, a set of configuration data out of the sets #1, #2, #3, #4, #5 and #6 is determined. In the present example, this selection can be based on the selector bits z₀ and z₁. In an example, selector bits z₀ and z₁ may indicate a unit of program execution, e.g., a thread related to a specific application that triggered the event. However, selector bits z₀ and z₁ may also relate to other software units, such as hardware drivers that may have triggered the event. In other examples, the selection of a set of configuration data may also be based on the event identifier (e.g., an interrupt address, having M bits in FIG. 10). Additionally, or alternatively, the selection may be based on arguments provided with the event identifier, such as information defining return and data transfer behavior, conditional code execution, execution level (i.e., execution priority), etc., or on any combination of information available by configuration control means 255 at the time of conducting ERS control stage 904.

ERS control stage 904 may further configure the microcontroller system 200 corresponding to the determined set of configuration data. The ERS control stage may further trigger execution of the event service routine (ESR) 906 in order to service the event. In the present example, the most significant M bits may be used as the effective address of the program counter address PC_{ESR}. In other embodiments, the most significant M bits may directly serve as the program counter address PC_{ESR} pointing toward the first instruction of the event service routine in memory 280. After executing the event service routine, RETE stages 908 and 910 may restore the system configuration active upon receiving the event, as explained above. As an alternative, the most significant M bits may point toward the set of configuration data. In this alternative, the address of the PC_{ESR} or pointer to PC_{ESR} may be derivable using a known offset. In the example according to FIG. 10, the sets of configuration data #1, #2, #3, #4, #5 and #6, and the program instructions related to the respective event service routines are stored in separate sections of memory 280. This may be advantageous in cases where one of the configuration data sets may apply to different events.

While in the foregoing example, the plurality of sets of configuration data is stored in respective portions of memory 280, and a pointer (illustrated by the dashed arrow in FIG. 10) is obtained that points toward the start address related to configuration data set #1, other methods of identifying the plurality of sets of configuration data or the determined set of configuration data based on an event identifier may be used. For example, instead of using selector bits z₀ and z₁, a memory address pointing toward the program code related to the event service routine and the determined or selected set of configuration data may be stored in contiguous portions of the memory, such as memory 280. In this example, the memory address may be derivable from the event identifier. By storing a set of configuration data including coordination information together with the program code of the event service routine, providing of new event service routines together with their respective configurations including the coordination data to arrive at these configurations by system programmers may be facilitated. In another example, a memory address pointing toward the program code associated with an event service routine and a memory address pointing toward a set of configuration data may be stored in contiguous portions of the memory, such as memory 280. In this example, a pointer pointing towards the contiguous portion of the memory storing the memory address of the event service routine and the memory address of the determined set of configuration data may be derivable from the event identifier. By this kind of indirect reference to the program code of the event service routine and the configuration data, it is possible to more flexibly determine a configuration associated with an event. Furthermore, the event service routine program code and the configuration data may be stored in different portions of memory. For example, the different portions or sections of memory may have different protection states providing additional security.

According to some aspects of the present disclosure, the program code associated with an event service routine for handling the event and at least one of the sets of configuration data including the coordination information is stored in contiguous portions of the memory. In these aspects, the memory location of the system setting information can be easily derived, e.g., from the program counter pointing toward the block of memory locations. Furthermore, the sets of configuration data or at least one of those (e.g., the one determined from the plurality of sets of configuration data) can be loaded from the memory together with the program instructions of the event service routine e.g., by using a burst read mode, which accelerates reception of the system setting information associated with the one or more operation modes. Moreover, by storing the sets of configuration data together with the respective program code, the related sets of configuration data including the coordination information can be included in a simple fashion, when a new application or other function is downloaded and installed on the microcontroller system.

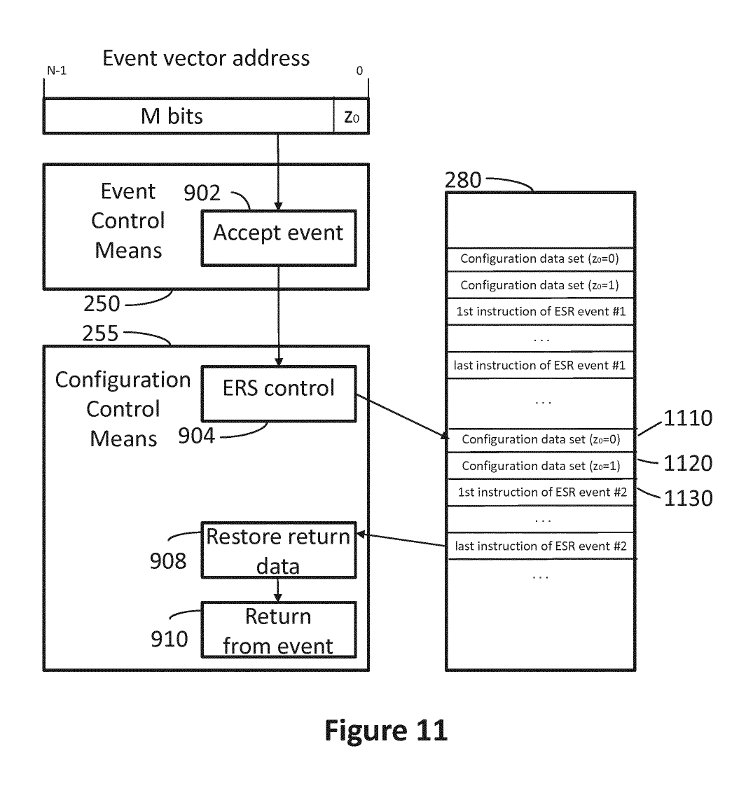

Storing the configuration data including the coordination information and the program code associated with the event service routine in contiguous portions of the memory may in particular be useful where each event shall be configured with different configuration data including coordination information. FIG. 11 schematically illustrates processing of an event according to an example technique related to aspects of the present disclosure, where program code associated with an event service routine for handling the event the said sets of configuration data is stored in contiguous portions of the memory.

In this example, an event may arrive having an event vector of length N bits as illustrated in FIG. 11. The most significant M bits of the event vector may be used as the program counter address PC_{ESR}. However, as can be seen from FIG. 11, the program counter PC_{ESR} does not directly point toward the first instruction of the event service routine (ESR). Rather, in this example, the code of each event service routine (e.g., ESRs related to event #1 and #2, as shown in FIG. 11) is preceded by configuration data sets including coordination information associated with each event, respectively. Hence, in this example, the sets of configuration data and the program code related to the event service routine is stored in consecutive sections of memory 280. Furthermore, in this example, two configuration data sets are associated with each event. In this way, it is possible to assign different data individually based on the event. In the present example, the event vector address comprises one selector bit z₀, which is used to determine a set of configuration data of the two sets of configuration data in ERS control stage 904, accordingly, as explained above. Additionally, or alternatively, an index data for extending the range of possible selections beyond the single bit of z₀ may enable more than two sets of configuration data.

In this example, it may not be necessary for ERS control stage 904 to retrieve the sets of configuration data and the instructions of the event service routine separately. Instead, the first M bits of the event vector address are used as a pointer pointing toward the first configuration data set. Furthermore, the length of the configuration data sets is known to configuration control means, for example by an initialization of configuration control means 255. Therefore, ERS control stage 904 can derive the program counter PC_{ESR} pointing toward the first instruction of the event service routine. For example, in FIG. 11, event #2 may have been received. Hence, a pointer pointing toward the first configuration data set 1110 of the two sets of configuration data 1110 and 1120 may be derivable from the event vector address. ERS control stage 904 may, based on the event vector address, and the known length of the sets of configuration data 1110 and 1120 derive the program counter PC_{ESR} pointing toward the first instruction 1130 of event service routine associated with event #2. In an example, ERS control stage 904 may jointly retrieve configuration data sets 1110 and 1120 including respective coordination information, as well as at least a part of the program code related to event #2 from memory 280, using a block reading command. Such commands provide effective reading of the data from a memory.

According to aspects of the present disclosure, the collecting of one or a plurality of sets of configuration data may comprise collecting one or a plurality of sets of configuration data from the memory based on at least one pointer pointing toward at least one set of configuration data stored in a portion of the memory. In some implementations, the amount of data to be collected may be large. In these situations, it may be desirable to reduce the amount of data that has to be retrieved from memory 220, 225 or 280 during the collection. Hence, instead of physically collecting the data, only a pointer may be received or derived, which points towards the configuration data. In some examples, a single pointer may be obtained pointing towards a contiguous portion of the memory storing the sets of configuration data. In these examples, an offset may be determined upon determining a set of configuration data of the sets of configuration data that is used for configuring the microcontroller system. In other examples, pointers to individual sets of configuration data may be obtained or derived. In these examples, a pointer pointing toward the particular set of configuration data may be selected upon determining a set of configuration data of the sets of configuration data.

In some aspects of the present disclosure, the configuration control means 255 may include a state machine, operable to coordinate the transition to said configuration according to said coordination information, wherein said state machine is operable to coordinate the transition to said configuration within an atomic process.

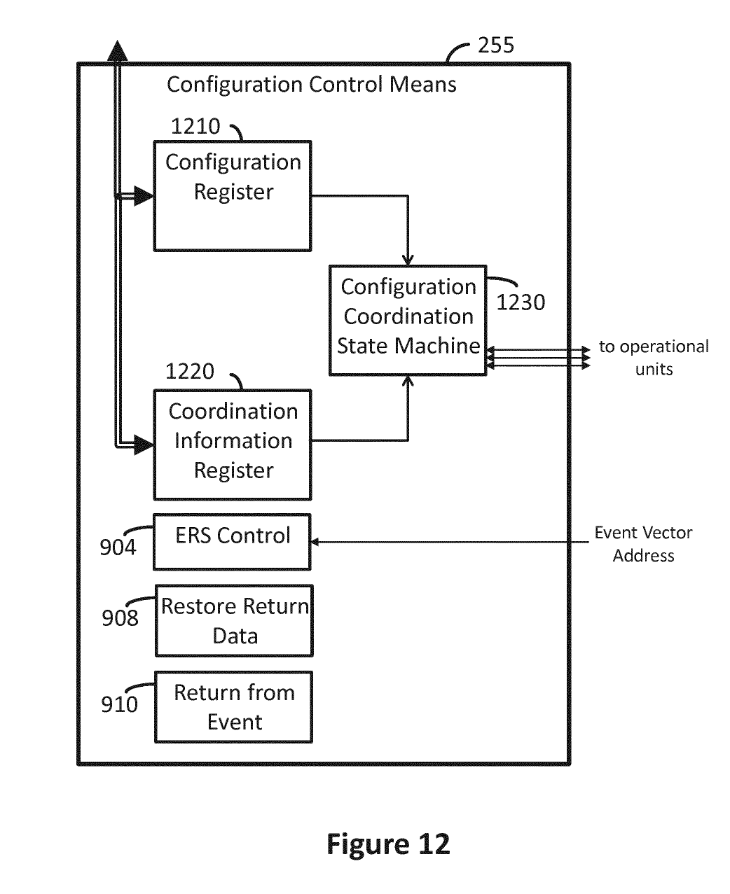

FIG. 12 illustrates a simplified diagram of a configuration control means 255 of a microcontroller system, such as microcontroller system 200, according to aspects of the present disclosure. The functionality of configuration control means 255 as shown in FIG. 12 may correspond to the functionality as explained in detail above. As shown in FIG. 12, configuration control means 255 may include a configuration register 1210 and a coordination information register 1220. Furthermore, configuration control means 255 may include a configuration coordination state machine 1230. In some examples, configuration control means 255 may be operable to control event-based configuration and to coordinate configuration based on an event as described above. To this end, configuration control means 255 may additionally include means for performing ERS control stage 904, means to restore return data 908, and means to return from an event 910. The afore-mentioned operational means may be implemented by means of electronic circuits (i.e., hardware), by means of a processor being configured to perform the functionality of said means, including software to be executed on said processor, or any combination thereof. In this respect, any processing means that, e.g., implements, the functionality of a state machine, may be regarded as an implementation of state machine 1230. As shown in FIG. 12, configuration control means 255 may interface to bus interface 240, or directly to bus 270. Furthermore, configuration control means 255 may interface with the other operational units of the microcontroller system 200 as shown in FIG. 2. In some examples, a dedicated bus system for providing configuration signals between configuration control means 255 and other operational units is provided. However, in some examples, configuration signals may be provided via bus 270, as mentioned above. In some aspects, configuration control means 255 may also be adapted to receive event vector addresses, e.g., from the event control means 250. These vector addresses may be provided by a dedicated interface. In some examples, the interface may involve bus 270.

In operation, configuration control means 255 may store the sets of configuration data including a target configuration in configuration register 1210. Furthermore, related coordination information may be stored in coordination register 1220. A set of configuration data may be determined by configuration control means 255 by the methods as explained above. In order to configure the microcontroller system corresponding to the determined set of configuration data, configuration state machine 1230 may receive the configuration from a configuration register 1210, and the coordination information from coordination information register 1220. Hence, one or a plurality of coordination states, the corresponding configuration, and the respective state transition function is provided to configuration coordination state machine 1230. Configuration coordination state machine 1230 then performs the configuration, wherein each coordination state may be associated with partly configuring the respective at least one operational unit according to the target configuration, and/or configuring the respective at least one operational unit by an intermediate configuration. In some examples, configuration state machine 1230 may perform operations as described with FIGS. 4, 6 and 8 above. However, the functionality of configuration coordination state machine 1230 is not limited to these examples. In some examples, configuration control means 255 may be operable to control event-based configuration and to coordinate configuration based on an event as described above. In these cases, ERS control stage may switch from execution of the process that was present when the event arrived to the execution event service routine (ESR) for handling the event as described in detail above. Furthermore, in some examples, configuration control means 255 may also perform the steps necessary to return from the event using means to restore return data 908, and means to return from an event 910. In some implementations, configuration register 1210, coordination information register 1220, and configuration state machine 1230 may be part of the means for performing ERS control stage 904. However, any other suitable partition of operational means to implement configuration control means 255 may be employed.

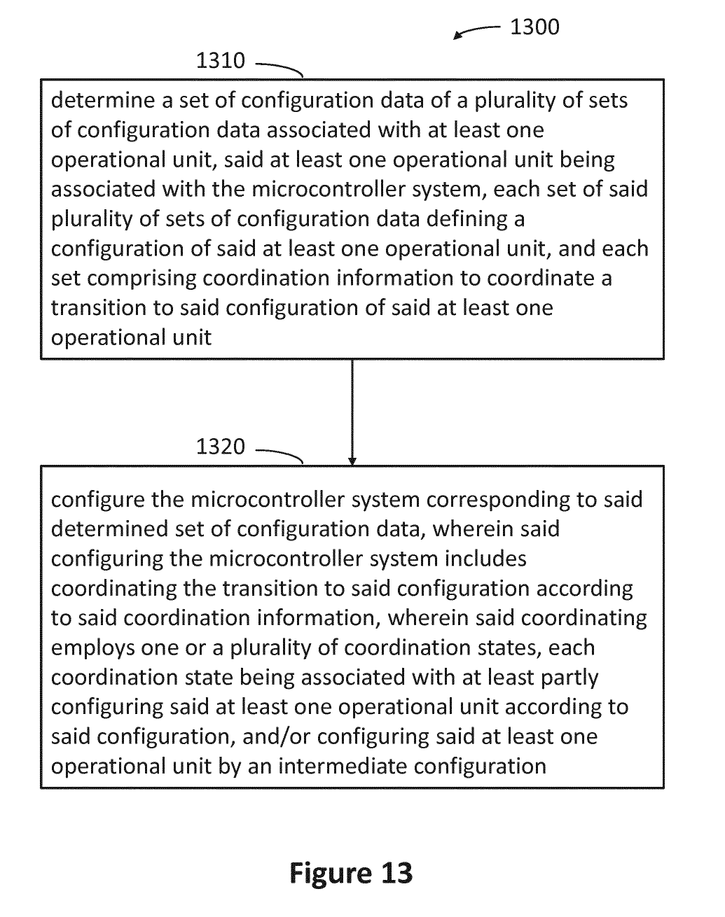

FIG. 13 shows a block diagram illustrating a method according to aspects of the present disclosure. In some embodiments, the method 1300 may be performed by portions of the microcontroller system 200 as shown in FIG. 2, for example, by event control means 250 and/or configuration control means 255, as explained above. However, the invention may not be limited thereto. At 1310, the method includes determining a set of configuration data of a plurality of sets of configuration data associated with at least one operational unit, said at least one operational unit being associated with the microcontroller system, each set of configuration data of said plurality of sets of configuration data defining a configuration of said at least one operational unit, and each set comprising coordination information to coordinate a transition to said configuration of said at least one operational unit. Furthermore, at 1320, the microcontroller system 200 is configured corresponding to said determined set of configuration data, wherein said configuring the microcontroller system includes coordinating the transition to said configuration according to said coordination information, wherein said coordinating employs one or a plurality of coordination states, each coordination state being associated with partly configuring said at least one operational unit towards said configuration, and/or configuring said at least one operational unit by an intermediate configuration.

As explained in detail above with respect to exemplary examples related to microcontroller system 200, the method as explained above generally defines a “choreography” to coordinate the transition or the transitions to a configuration (e.g., a first configuration) of one or more operational units. By determining a set of configuration data of the plurality of sets of configuration data according to method 1300, the application designer or programmer of the microcontroller system can use one or more different alternative sets of configuration data related to the configuration of the operational unit(s) to tailor power consumption and/or operational speed.

In some aspects, the techniques as explained above may be implemented by a computer program comprising program instructions executable to implement all steps of the method. The computer program may be associated with a computer program product directly loadable into the internal memory of a digital computer, comprising software code portions for performing the steps of said method when said product is run on a computer. However, the program instructions as mentioned above may also serve to implement the techniques as described herein by electronic circuits. For example, the program instructions may include hardware description language code. In some embodiments, corresponding functions of the computer program may be stored on computer-readable medium having computer-executable instructions adapted to cause the computer system to perform one of the methods as described above.

The various components, configurations, operations, portions, operational units, functional islands, operational modules, circuits, event control means, configuration control means, methods and steps, etc., have been described generally in terms of their functionality. Whether such functionality is implemented as hardware or processor executable instructions depends upon the particular application and design constraints imposed by the overall microcontroller system. Additionally, the various operations of methods described above may be performed by any suitable means capable of performing the operations, such as hardware and/or software components, electronic circuits and/or modules. Any operation as illustrated above may be performed by corresponding functional means capable of performing the operations, such as event control means 250 and configuration control means 255. Skilled persons in the art may implement the described functionality in varying ways for each particular application, but such implementation decisions should not be interpreted as causing a departure from the scope of the present disclosure.

1. A microcontroller system, comprising:
a central processing unit;
memory associated with said microcontroller system;
configuration control means operable to:
determine a set of configuration data of a plurality of sets of configuration data associated with at least one operational unit, said at least one operational unit being associated with the microcontroller system, each set of said plurality of sets of configuration data defining a configuration of said at least one operational unit, and each set comprising coordination information to coordinate a transition to said configuration of said at least one operational unit; and
configure the microcontroller system corresponding to said determined set of configuration data, wherein said configuring the microcontroller system includes coordinating the transition to said configuration according to said coordination information, wherein said coordinating employs one or a plurality of coordination states, each coordination state being associated with at least partly configuring said at least one operational unit according to said configuration, and/or configuring said at least one operational unit by an intermediate configuration.

2. The microcontroller system of claim 1, wherein each set of said plurality of sets of configuration data includes one or more parameter values being stored in a data structure, the parameter values defining said configuration of said at least one operational unit and said coordination information, and wherein the configuration control means is further operable to:
identify a data structure of the determined set of configuration data and extract the parameter values.

3. The microcontroller system of claim 1, wherein said plurality of sets of configuration data comprise at least two sets of configuration data defining a same configuration of said at least one operational unit, wherein each of said at least two sets of configuration comprise different coordination information.

4. The microcontroller system of claim 1, wherein
the coordination information comprises an indication of a sequence of said one or more coordination states.

5. The microcontroller system of claim 1, wherein the coordination information includes an indication of a latency for a transition from one of said coordination states to a next state.

6. The microcontroller system of claim 1, wherein the coordination information comprises trigger information for a transition from one of said coordination states to a next state, said trigger information identifying a trigger condition.

7. The microcontroller system of claim 6, wherein said trigger information includes branching information for a transition from said one of said coordination states to either a first next state or a second next state.

8. The microcontroller system of claim 7, wherein the configuration control means is further operable to:
determine branching information based on said determined set of configuration data;
adjust said configuration based on the branching information.

9. The microcontroller system of claim 1, further comprising:
event receiving means operable to receive an event;
wherein said configuration control means is further operable to:
collect said plurality of sets of configuration data related to said event from said memory;
wherein said determining a set of configuration data is based on said collected plurality of sets of configuration data.

10. The microcontroller system of claim 9, wherein said configuration control means is operable to determine the set of configuration data based at least in part on event execution control data associated with the event.

11. The microcontroller system of claim 10, wherein, said event execution control data comprises system state information associated with the execution status of the microcontroller system.

12. The microcontroller system of claim 11, wherein said system state information includes a system configuration active upon receiving the event.

13. The microcontroller system of claim 9, wherein program code associated with an event service routine for handling the event and said plurality of sets of configuration data is stored in respective portions of said memory, wherein a memory location for collecting said sets of configuration data is based on an event identifier associated with said event.

14. The microcontroller system of claim 13, wherein said program code associated with an event service routine for handling the event and at least one of said sets of configuration data is stored in contiguous portions of said memory.

15. The microcontroller system of claim 1, wherein said configuration control means includes a state machine operable to coordinate the transition to said configuration according to said coordination information, wherein said state machine is operable to coordinate the transition to said configuration at least in part within an atomic process.

16. A method of coordinating a configuration of a microcontroller system, the method comprising the steps of:
determining a set of configuration data of a plurality of sets of configuration data associated with at least one operational unit, said at least one operational unit being associated with the microcontroller system, each set of said plurality of sets of configuration data defining a configuration of said at least one operational unit, and each set comprising coordination information to coordinate a transition to said configuration of said at least one operational unit; and
configuring the microcontroller system corresponding to said determined set of configuration data, wherein said configuring the microcontroller system includes coordinating the transition to said configuration according to said coordination information, wherein said coordinating employs one or a plurality of coordination states, each coordination state being associated with at least partly configuring said at least one operational unit according to said configuration, and/or configuring said at least one operational unit by an intermediate configuration.

17. The method of claim 16, wherein each set of said plurality of sets of configuration data includes one or more parameter values being stored in a data structure, the parameter values defining said configuration of said at least one operational unit and said coordination information, and wherein the method further comprises:
identifying a data structure of the determined set of configuration data and extract the parameter values.

18. The method of claim 16, wherein said plurality of sets of configuration data comprise at least two sets of configuration data defining a same configuration of said at least one operational unit, wherein each of said at least two sets of configuration comprise different coordination information.

19. The method of claim 16, wherein the coordination information comprises an indication of a sequence of said one or more coordination states.

20. The method of claim 16, wherein the coordination information includes an indication of a latency for a transition from one of said coordination states to a next state.

21. The method of claim 16, wherein the coordination information comprises trigger information for a transition from one of said coordination states to a next state, said trigger information identifying a trigger condition.

22. The method of claim 21, wherein said trigger information includes branching information for a transition from said one of said coordination states to either a first next state or a second next state.

23. The method of claim 22, further comprising:
determining branching information based on said determined set of configuration data;
adjusting said configuration based on the branching information.

24. The method of claim 16, further comprising:
collecting said plurality of sets of configuration data related to an event from a memory associated with said microcontroller system;
wherein said determining a set of configuration data is based on said collected plurality of sets of configuration data.

25. The method of claim 24, further comprising determining the set of configuration data based at least in part on event execution control data associated with the event.

26. The method of claim 25, wherein, said event execution control data comprises system state information associated with the execution status of the microcontroller system.

27. The method of claim 26, wherein said system state information includes a system configuration active upon receiving the event.

28. The method of claim 24, wherein program code associated with an event service routine for handling the event and said plurality of sets of configuration data is stored in respective portions of said memory, wherein a memory address for collecting said sets of configuration data is based on an event identifier associated with said event.

29. The method of claim 28, wherein said program code associated with an event service routine for handling the event and at least one of said plurality of sets of configuration data is stored in contiguous portions of said memory.

30. The method of claim 16, wherein said coordinating the transition to said configuration is at least in part performed within an atomic process.

31. Computer program comprising program instructions which are computer-executable to implement the steps of:
determining a set of configuration data of a plurality of sets of configuration data associated with at least one operational unit, said at least one operational unit being associated with the microcontroller system, each set of said plurality of sets of configuration data defining a configuration of said at least one operational unit, and each set comprising coordination information to coordinate a transition to said configuration of said at least one operational unit; and
configuring the microcontroller system corresponding to said determined set of configuration data, wherein said configuring the microcontroller system includes coordinating the transition to said configuration according to said coordination information, wherein said coordinating employs one or a plurality of coordination states, each coordination state being associated with at least partly configuring said at least one operational unit according to said configuration, and/or configuring said at least one operational unit by an intermediate configuration.
